(19) United States
(12) Patent Application Publication
(10) Pub. No.: US 2019/0291987 A1
(43) Pub. Date: Sep. 26, 2019

(54) IMAGE READING APPARATUS AND IMAGE READING METHOD

(71) Applicants: KABUSHIKI KAISHA TOSHIBA, Tokyo (JP); TOSHIBA TEC KABUSHIKI KAISHA, Tokyo (JP)

(72) Inventor: Shohei Yamazaki, Mishima Shizuoka (JP)

(21) Appl. No.: 15/933,460

(22) Filed: Mar. 23, 2018

(51) Int. Cl. B65H 5/06; B65H 47/00; H04N 1/00

(52) U.S. Cl. CPC B65H 5/06; B65H 47/00; B65H 2301/45; B65H 2301/51; B65H 2301/33312; H04N 1/00647

(57) ABSTRACT

An image reading apparatus according to an embodiment includes a first sensor, a roller, a correction unit, a second sensor, a control unit, and a scanner. Upstream to downstream positions with regard to a transportation direction of the sheet are determined in the following order: the first position, a second position, a third position. The first sensor detects the presence or absence of a fold of the sheet in the first position. If it is detected in the first position that the fold is present, the roller transports a sheet in a reverse transportation direction. The correction unit corrects the fold in the first position. The second sensor detects the presence or absence of the fold in the second position. If it is detected in the second position that the fold is present, the control unit controls drive of the roller in such a manner that the sheet is transported up to the first position in the reverse transportation direction. The scanner reads an image on the sheet of which the fold is corrected in the first position.

### FIELD

Embodiments described herein relate generally to an image reading apparatus and an image reading method.

### BACKGROUND

An image reading apparatus reads an image on a surface of a sheet that is transported. In some cases, a fold occurs on a corner portion of the sheet. If the fold of the corner portion of the sheet cannot be corrected before the image is read, the image reading apparatus cannot read an image on a portion hidden behind the fold. However, in some cases, an image reading apparatus in the related art cannot improve the probability that the fold of the sheet will be corrected.

### DESCRIPTION OF THE DRAWINGS

FIG. 1 is an external-view diagram of an example of an entire configuration of an image processing apparatus, in the embodiment.

FIG. 2 is an external-view diagram of an example of an entire configuration of an image reading unit, in the embodiment.

FIG. 3 is a block diagram illustrating an example of a hardware configuration of the image processing apparatus, in the embodiment.

FIG. 4 is a side-view diagram illustrating a correction unit that is installed in such a manner as to come into contact with a sheet, in the embodiment.

FIG. 5 is a bird's eye-view diagram illustrating the correction unit that is installed in such a manner as to come into contact with the sheet, in the embodiment.

FIG. 6 is a bird's eye-view diagram illustrating the sheet that is transported in a reverse transportation direction, in the embodiment.

FIG. 7 is a bird's eye-view diagram illustrating the correction unit before coming into contact with a fold, in the embodiment.

FIG. 8 is a bird's eye-view diagram illustrating the correction unit and a roller that are correcting the fold, in the embodiment.

FIG. 9 is a bird's eye-view diagram illustrating the roller that is correcting the fold, in the embodiment.

FIG. 10 is a bird's eye-view diagram illustrating the sheet of which the fold is corrected, in the embodiment.

FIG. 11 is a side-view diagram illustrating an auxiliary correction unit that is installed in such a manner as to come into contact with a sheet, in the embodiment.

FIG. 12 is an external-view diagram of an example of the sheet that is inclined with respect to a transportation direction, in the embodiment.

FIG. 13 is a flowchart illustrating operation of the image reading unit, in the embodiment.

### DETAILED DESCRIPTION

An image reading apparatus according to an embodiment includes a first sensor, a roller, a correction unit, a second sensor, a control unit, and a scanner. Upstream to downstream positions with regard to a transportation direction of the sheet are determined in the following order: the first position, a second position, a third position. The first sensor detects the presence or absence of a fold of the sheet in the first position. If it is detected in the first position that the fold is present, the roller transports a sheet in a reverse transportation direction. The correction unit corrects the fold in the first position. The second sensor detects the presence or absence of the fold in the second position. If it is detected in the second position that the fold is present, the control unit controls drive of the roller in such a manner that the sheet is transported up to the first position in the reverse transportation direction. The scanner reads an image of the sheet of which the fold is corrected in the first position, in the third position.

An image reading apparatus and an image reading method will be described below with reference to the drawings.

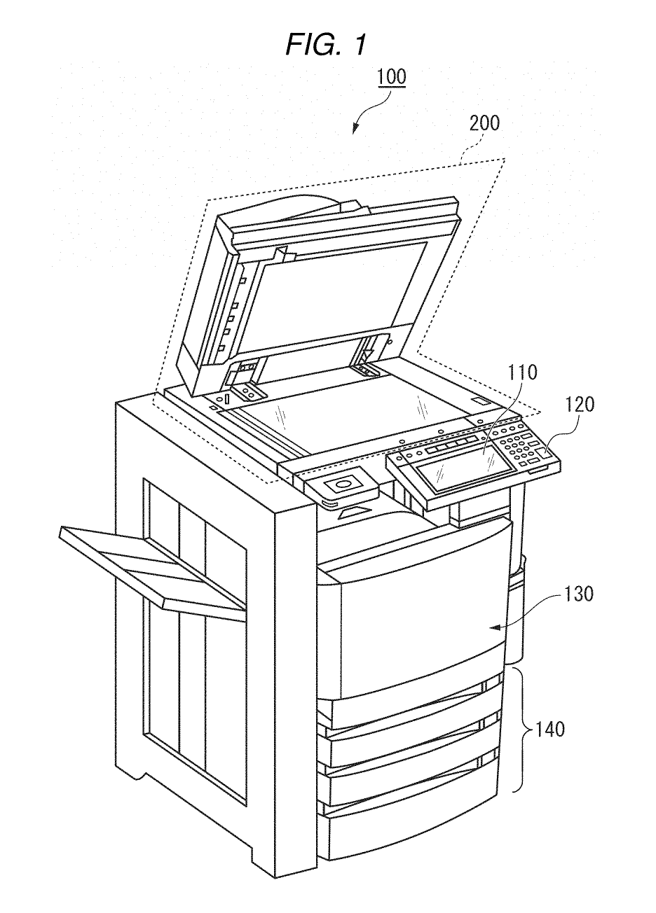

FIG. 1 is an external-view diagram of an example of an entire configuration of an image processing apparatus 100. The image processing apparatus 100 is an image forming apparatus, for example, a multifunction machine. The image processing apparatus 100 includes a display 110, a control panel 120, a printer 130, a sheet accommodating unit 140, and an image reading unit 200. The printer 130 of the image processing apparatus 100 may be an apparatus that causes a toner image to be fixed, and may be an ink jet-type apparatus.

The image processing apparatus 100 reads an image that is expressed on a sheet, generates digital data, and generates an image file. The sheet, for example, is an original document, a sheet of paper on which a character, an image, or the like is expressed, or the like. The sheet may be any type of sheet as long as it can be read by the image processing apparatus 100.

The display 110 is an image display apparatus, such as a liquid crystal display or an organic electro luminescence (EL) display. Various pieces of information relating to the image processing apparatus 100 are displayed on the display 110.

The control panel 120 has a plurality of buttons. A user operation is performed on the control panel 120. The control panel 120 outputs a signal in accordance with an operation that is performed by a user, to the control unit of the image processing apparatus 100. The display 110 and the control panel 120 may be configured to be integrally combined with each other into a single touch panel.

The printer 130 forms an image on a sheet, based on image information that is generated by the image reading unit 200, or image information that is received through a communication path. The printer 130, for example, forms an image with the following processing. An image forming unit of the printer 130 forms an electrostatic latent image on a photoconductive drum based on the image information. The image forming unit of the printer 130 forms a visible image by causing a developing agent to be adhered to the electrostatic latent image. As a specific example of the developing agent, there is a toner. A transfer unit of the printer 130 transfers the visible image on a sheet. A fixing unit of the printer 130 causes the visible image to be fixed to the sheet by performing heating and pressurization on the sheet. The sheet on which the image is formed may be a sheet that is accommodated in the sheet accommodating unit 140, and may be a sheet that is manually fed.

The sheet accommodating unit 140 accommodates a sheet that is used for image formation in the printer 130.

The image reading unit 200 read reading-target image information as light brightness and darkness. The image reading unit 200 records the image information that is read. The image information that is recorded may be transmitted to another information processing apparatus through a network. The recorded image information may be image-formed by the printer 130 on a sheet.

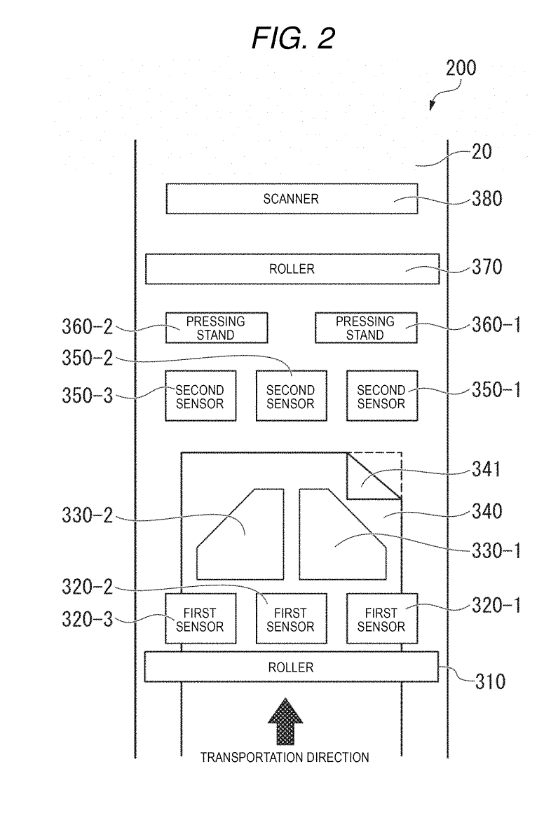

FIG. 2 is an external-view diagram of an example of an entire configuration of an image reading unit 200. The image reading unit 200, as a reversing automatic document feeder (RADF) or a dual scan document feeder (DSDF), includes a roller 310, first sensors 320-1 to 320-N, correction units 330-1 to 330-N, second sensors 350-1 to 350-N, pressing stands 360-1 to 360-M, and a roller 370. The image reading unit 200 further includes an original document stand 20 and a scanner 380. In FIG. 2, as an example, the letter N is 3, and the letter M is 2.

A position hereinafter includes the position itself and the vicinity thereof. The roller 310 is installed in the first position in the original document stand 20. The first position is an upstream position with respect to a transportation direction of the sheet 340. The roller 310 rotates under the control of a processor as the control unit. The roller 310 transports the sheet 340 in a transportation direction along the original document stand 20 and in the reverse transportation direction. The transportation direction is a direction from the roller 310 to the roller 370. The reverse transportation direction is a direction from the roller 370 to the roller 310.

The first sensor 320 is an optical sensor. The first sensors 320-1 to 320-N are arranged in the width direction of the sheet 340. That is, the first sensor 320-1 to 320-N are arranged in a direction orthogonal to the transportation direction. The first sensor 320 detects in the first position on the original document stand 20 whether the fold of the sheet 340 is present or absent, based on the presence or absence of light that is reflected off the sheet 340.

In an initial state, the correction unit 330 is evacuated to a position that is located a distance from an upper surface of the sheet 340. By evacuating the correction unit 330, the correction unit 330 can reduce the possibility of causing damage to the sheet 340. The correction unit 330 moves to a position that comes into contact with the upper surface of the sheet 340 under the control of the processor as the control unit.

The correction unit 330 comes into contact with the fold that protrudes from the upper surface of the sheet 340 that is transported in the reverse transportation direction, and thus corrects the fold. For example, a shape of a portion that comes into contact with the sheet 340, of the correction unit 330 is a plate shape. For example, a width of the correction unit 330 is approximately half of a width of the sheet 340.

A shape of the correction unit 330 is designed in advance in such a manner that an area that comes into contact with a fold of a corner portion of the sheet 340 is increased. Accordingly, the correction unit 330 can set stress not to build up on a crease in the fold of the sheet 340. The fold of the sheet 340 may be a tear or a chipped portion of the sheet 340 other than the fold of the sheet.

The second sensor 350 is an optical sensor. The second sensors 350-1 and 350-N are arranged in the width direction of the sheet 340. The second sensor 350 detects in the second position on the original document stand 20 whether the fold of the sheet 340 is present or absent, based on the presence or absence of light that is reflected off the sheet 340. The second position is a position that is located more downstream with respect to the transportation direction of the sheet 340 than the first position.

The pressing stand 360 is a stand for pressing the sheet 340 in the vicinity of the roller 370.

Even if the sheet 340 is pressed by the pressing stand 360, the roller 370 possibly transports the sheet 340.

The roller 370 is installed in the second position in the original document stand 20. The roller 370 rotates under the control of a processor as the control unit. The roller 370 transports the sheet 340 in the transportation direction along the original document stand 20 and in the reverse transportation direction.

The scanner 380 is installed in the third position in the original document stand 20. The third position is a position that is located more downstream with respect to the transportation direction of the sheet 340 than the second position. The scanner 380 reads an image of a surface of the sheet 340 of which a fold 341 is corrected in the first position and the second position, in the third position.

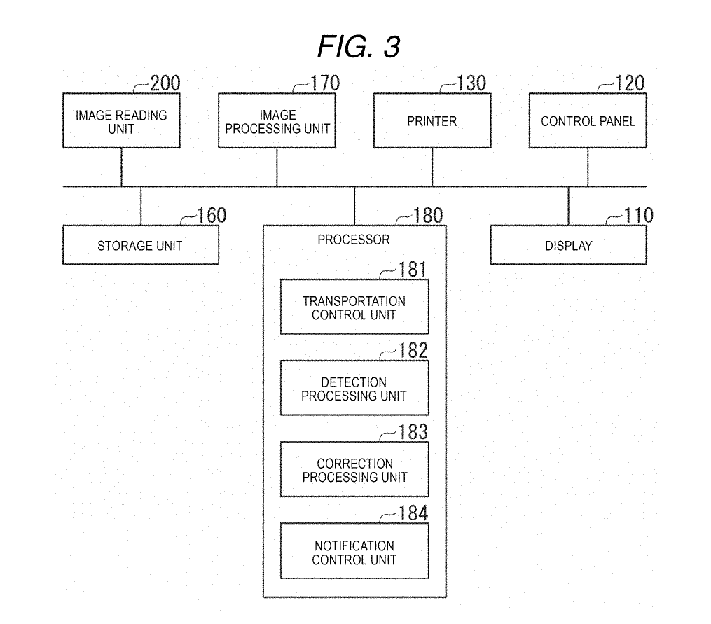

FIG. 3 is a block diagram illustrating an example of a hardware configuration of an image processing apparatus 100. The image processing apparatus 100 includes a display 110, a control panel 120, a printer 130, a bus 150, a storage unit 160, an image processing unit 170, a processor 180, and the image reading unit 200.

The bus 150 transfers data between of each of the functional units of the image processing apparatus 100.

The storage unit 160 has a flash memory or a non-volatile storage medium (non-temporary storage medium) such as a hard disk drive (HDD). A program that is executed by the processor 180, image data, and various setting values are stored in the storage unit 160. The setting value, for example, is a setting value of a rotation speed (transportation speed) of the roller. The storage unit 160 may further have a random access memory (RAM).

The image processing unit 170 performs image processing on the image that is read by the image reading unit 200. The image processing unit 170 output a result of the image processing to the printer 130.

The processor 180 is a central processing unit (CPU). The processor 180 executes the program that is stored in the storage unit 160. A portion of the processing that is performed by the processor 180 may be realized using hardware such as a large scale integration (LSI) circuit or an application specific integrated circuit (ASIC).

The processor 180 includes a transportation control unit 181, a detection processing unit 182, a correction processing unit 183, and a notification processing unit 184.

The transportation control unit 181 controls a rotation direction and a rotation speed of each of the roller 310 and the roller 370. The transportation control unit 181 controls the rotation direction and the rotation speed of the roller 310, and thus controls the transportation direction and a transportation speed of the sheet 340. The transportation direction of the sheet 340 is determined according to the rotation direction of the roller 310. A transportation speed and a reverse transportation speed of the sheet 340 is determined according to a rotation speed of the roller 310.

If the fold 341 of the sheet 340 is detected in the second position, the transportation control unit 181 may reverse the rotation direction of the roller 310. Accordingly, the correction unit 330 can re-perform the correction.

Until the number of times that the correction is re-performed, the transportation control unit 181 changes a reverse rotation speed of the roller 310 whenever the rotation direction of the roller 310 is reversed to the reverse direction. That is, until the number of times that the sheet 340 is transported in the reverse transportation direction reaches a threshold number of times, the transportation control unit 181 changes the reverse transportation speed of the sheet 340 whenever the sheet 340 is transported in the reverse transportation direction. The transportation control unit 181 delays the transportation speed and the reverse transportation speed whenever the sheet 340 is transported in the reverse transportation direction. For example, the threshold number of times is 3.

The transportation control unit 181 may change a distance that the sheet 340 is transported in the reverse transportation direction, whenever the sheet 340 is transported in the reverse transportation direction. For example, the transportation control unit 181 may increase the distance (an amount of return) that the sheet 340 is transported in the reverse transportation direction, whenever the sheet 340 is transported in the reverse transportation direction.

Based on results of the detection by the first sensor 320-1 to 320-N, the detection processing unit 182 detects the presence or absence of a fold of a corner portion of the sheet 340 that is passing through the first position. If the result of the detection by the first sensor 320-1 shows that a fold of the sheet 340 is present, the detection processing unit 182 determines that a fold is present on a corner portion of the sheet 340. If the result of the detection by the first sensor 320-N shows that a fold of sheet 340 is present, the detection processing unit 182 determines that a fold is present on another corner portion of the sheet 340.

Based on results of the detection by the second sensor 350-1 to 350-N, the detection processing unit 182 detects the fold of the corner portion of the sheet 340 that is passing through the second position. If the result of the detection by the second sensor 350-1 shows that a fold of the sheet 340 is present, the detection processing unit 182 determines that a fold is present on a corner portion of the sheet 340. If the result of the detection by the second sensor 350-N shows that a fold of the sheet 340 is present, the detection processing unit 182 determines that a fold is present on another corner portion of the sheet 340.

The correction processing unit 183 controls a position of the correction unit 330 that corrects an upper surface-side fold of the sheet 340. The correction processing unit 183 may control a position of another correction unit that corrects a lower surface-side fold of the sheet 340.

If processing that corrects the fold of the sheet 340 is re-performed, the correction processing unit 183 may change an angle that the correction unit 330 and the sheet 340 makes with respect to each other in such a manner that the correction unit 330 is stuck by the fold 341. For example, each time the sheet 340 is caused to be transported in the reverse transportation direction, the correction processing unit 183 may cause the correction unit 330 to be vertical to the sheet 340 in such a manner that the correction unit 330 is stuck by the fold.

The notification processing unit 184 displays a warning message on the display 110 according to a result of detection by the detection processing unit 182. If the fold of the sheet 340 is detected, the notification processing unit 184 displays the warning message that a fold or damage is present on the corner portion of the sheet 340, on the display 110. The notification processing unit 184 may display information guiding an operation that has to be performed by the user, on the display 110. For example, the operation that has to be performed by the user is an operation of removing the sheet 340.

If the sheet 340 is inclined with respect to the transportation direction (if a skew occurs), the notification processing unit 184 displays the warning message that the sheet 340 is inclined with respect to the transportation direction, on the display 110.

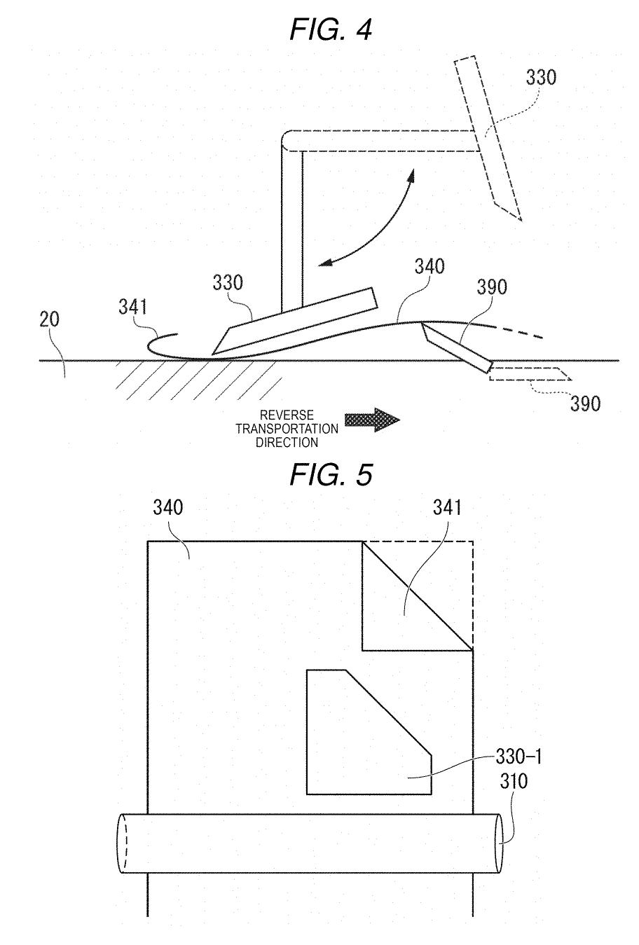

FIG. 4 is a side-view diagram illustrating the correction unit 330 that is installed in such a manner as to come into contact with the sheet 340. The image reading unit 200 may include the correction unit 390 in the original document stand 20. In an initial state, the correction unit 390 is evacuated without protruding from the original document stand 20. The correction unit 390 protrudes from the original document stand 20 in such a manner as to come into contact with a lower surface of the sheet 340, under the control of the correction processing unit 183. The correction unit 390 that protrudes comes into contact with the fold that protrudes from a lower surface of the sheet 340 that is transported in the reverse transportation direction, and thus corrects the fold.

Next, a procedure in which the correction unit 330 corrects the fold 341 of the sheet 340 will be described.

FIG. 5 is a bird's eye-view diagram illustrating the correction unit 330 that is installed in such a manner as to come into contact with the sheet 340. The correction processing unit 183 positions the correction unit 330-1 in such a manner as to come into contact with the upper surface of the sheet 340. The correction processing unit 183 may change an angle that the correction unit 330-1 and the sheet 340 makes with respect to each other, each time the sheet 340 is transported in the reverse transportation direction.

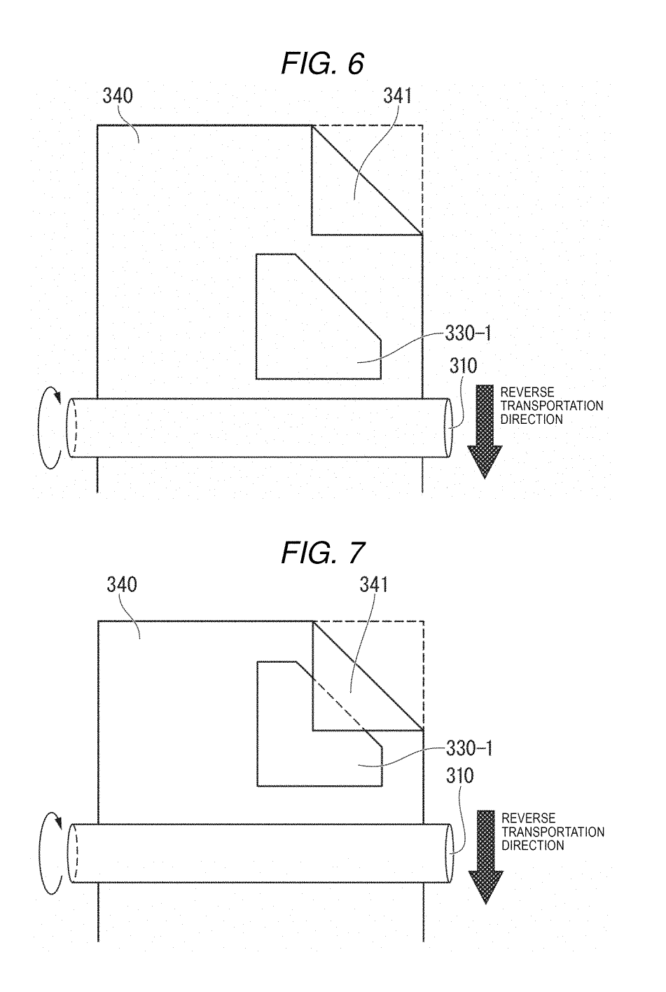

FIG. 6 is a bird's eye-view diagram illustrating the sheet 340 that is transported in the reverse transportation direction. The transportation control unit 181 transports the sheet 340 in the reverse transportation direction each time the roller 310 causes is caused to be rotated in the reverse direction.

FIG. 7 is a bird's eye-view diagram illustrating the correction unit 330 before coming into contact with the fold 341. The roller 310 transports the sheet 340 in the reverse transportation direction at a transportation speed different from the transportation speed that is applied when the sheet 340 is transported in the transportation direction. For example, the roller 310 transports the sheet 340 in the reverse transportation direction at a transportation speed lower than a predetermined transportation speed. The correction unit 330-1 is interposed between the fold 341 and the sheet 340.

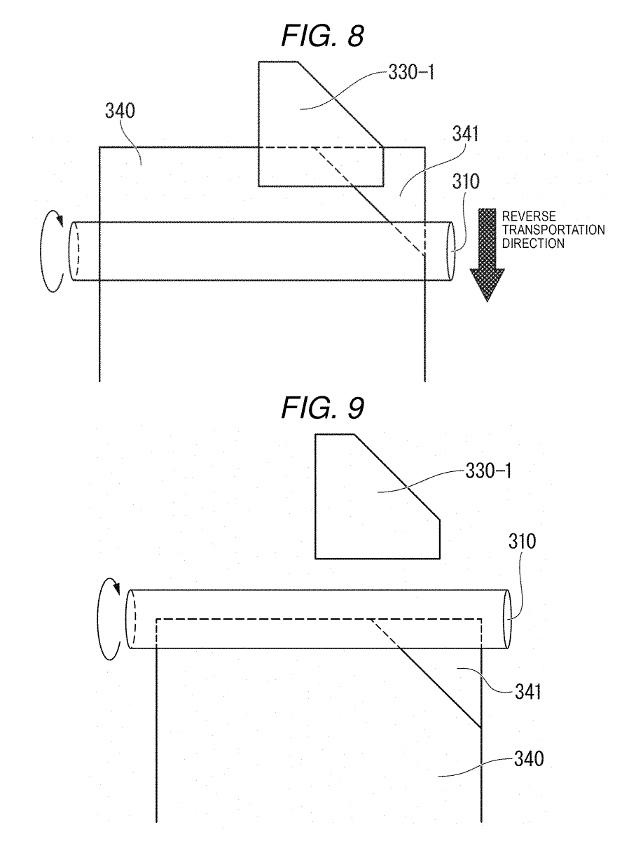

FIG. 8 is a bird's eye-view diagram illustrating the correction unit 330 and the roller 310 that are correcting the fold 341. The correction unit 330-1 comes into contact with the fold 341 that protrudes from the upper surface of the sheet 340 that is transported in the reverse transportation direction, and thus corrects the fold 341.

FIG. 9 is a bird's eye-view diagram illustrating the roller 310 that is correcting the fold 341. The roller 310 is clamped against the fold 341 and further corrects the fold 341.

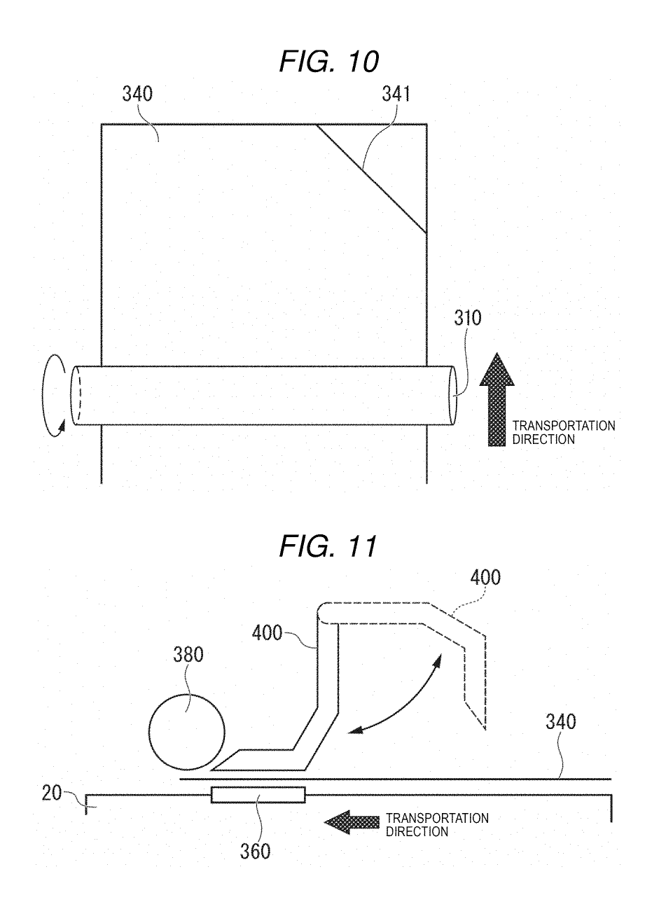

FIG. 10 is a bird's eye-view diagram illustrating the sheet 340 of which the fold 341 is corrected. The transportation control unit 181 causes the roller 310 to be rotated in the forward direction, and thus transport the sheet 340 of which the fold 341 is corrected, in the transportation direction.

FIG. 11 is a side-view diagram illustrating an auxiliary correction unit 400 that is installed in such a manner as to come into contact with the sheet 340. For example, a shape of a portion that comes into contact with the sheet 340, of the auxiliary correction unit 400 is a plate shape. For example, a width of the auxiliary correction unit 400 is approximately half of the width of the sheet 340.

In an initial state, the auxiliary correction unit 400 is evacuated to a position that is located a distance from the upper surface of the sheet 340. The correction processing unit 183 moves the auxiliary correction unit 400 in such a manner as to come into contact with the upper surface of the sheet 340 of which the fold 341 is corrected. For example, the correction processing unit 183 moves the auxiliary correction unit 400 to the vicinity of the pressing stand 360.

The auxiliary correction unit 400 that is moved to the vicinity of the pressing stand 360 presses down a trace of the fold 341 of the sheet 340. Accordingly, even if the tendency to make a crease is strong, the auxiliary correction unit 400 can prevent the fold of the sheet 340 from re-occurring. That is, even if the tendency to make a crease is strong, the auxiliary correction unit 400 can set the sheet 340 not to be entangled in the roller 370.

Next, a direction in which the inclination of the sheet 340 is detected will be described.

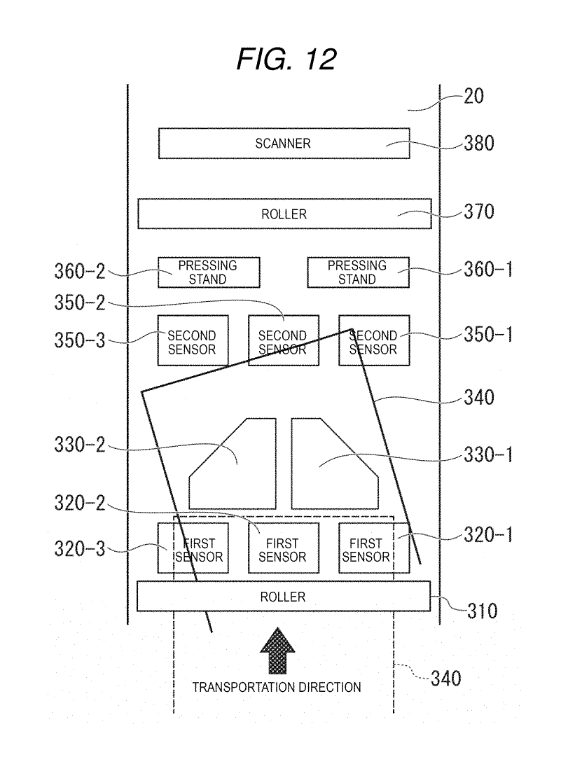

FIG. 12 is an external-view diagram of an example of the sheet 340 that is inclined with respect to the transportation direction. The detection processing unit 182 acquires each timing at which each of the first sensors 320-1 to 320-N detects that the sheet 340 passes. The detection processing unit 182 determines whether or not a difference between the first point in time at which the first sensor 320 detects the sheet 340 and the last point in time at which another first sensor 320 detects the sheet 340 is a prescribed time or less. If a difference between a point in time of the first detection and a last point in time of the first detection when it comes to the results of the detection by a plurality of first sensors 320 is a prescribe time or greater, the detection processing unit 182 determines that the sheet 340 is inclined in the first position.

The detection processing unit 182 acquires each timing at which each of the second sensors 350-1 to 350-N detects that the sheet 340 passes. The detection processing unit 182 determines whether or not a difference between the first point in time at which the second sensor 350 detects the sheet 340 and the last point in time at which another second sensor 350 detects the sheet 340 is a prescribed time or less. If a difference between a point in time of the first detection and a last point in time of the first detection when it comes to the results of the detection by a plurality of second sensors 350 is a prescribe time or greater, the detection processing unit 182 determines that the sheet 340 is inclined in the second position.

If the sheet 340 is determined as being inclined with respect to the transportation direction, the transportation control unit 181 may transport the sheet 340 up to a paper feeding stand in the reverse transportation direction.

Next, an example of operation of the image reading unit 200 will be described.

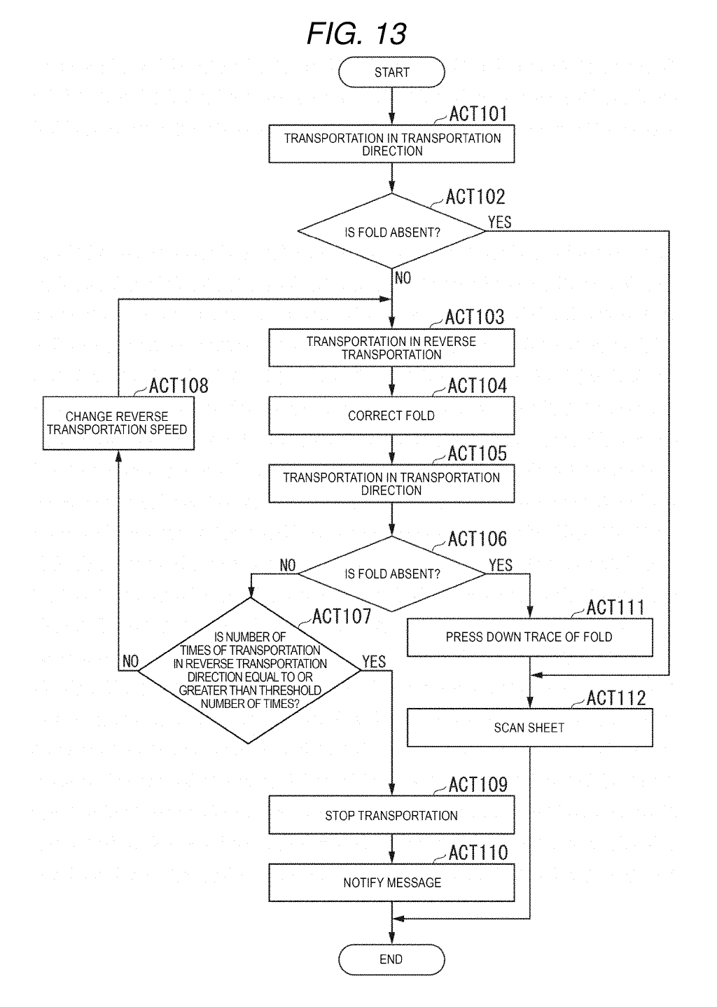

FIG. 13 is a flowchart illustrating the operation of the image reading unit 200.

The roller 310 transports the sheet 340 in the transportation direction (ACT 101).

The first sensor 320 detects whether or not the fold 341 of the sheet 340 is present, in the first position in the original document stand 20 (ACT 102).

If it is not detected in the first position in the original document stand 20 that the fold 341 of the sheet 340 is present (YES in ACT 102), the transportation control unit 181 proceeds to ACT 112.

If it is detected in the first position that the fold 341 of the sheet 340 is present (NO in ACT 102), the roller 310 transports the sheet 340 in the reverse transportation direction (ACT 103).

The installed correction unit 330 corrects the fold 341 in the first position (ACT 104).

The roller 310 transports the sheet 340 in the transportation direction (ACT 105).

The second sensor 350 detects whether or not the fold 341 of the sheet 340 is present, in the second position in the original document stand 20 (ACT 106).

If it is detected in the second position that the fold 341 is present (NO in ACT 106), the transportation control unit 181 acquires the number of times that the roller 310 transports the sheet 340 up to the first position in the reverse transportation direction. The transportation control unit 181 determines whether or not the number of times that the sheet 340 is transported in the reverse transportation direction is equal to or greater than the threshold number of times (ACT 107).

If the number of times that the sheet 340 is transported in the reverse transportation direction is equal to or greater than the threshold number of times (NO in ACT 107), the transportation control unit 181 changes a setting value of the reverse transportation speed. The transportation control unit 181 may change a setting value of a distance that the sheet 340 is transported in the reverse transportation direction. The correction processing unit 183 may change a setting value of the angle that the correction unit 330 and the sheet 340 that make with respect to each other (ACT 108). The transportation control unit 181 returns the processing to ACT 103. That is, the roller 310 re-transports the sheet 340 up to the first position in the reverse transportation direction at a speed that is based on the changed setting.

If it is not detected in the second position that the fold 341 is present (YES in ACT 106), the installed auxiliary correction unit 400 presses down the trace of the fold 341 of the sheet 341 (ACT 111).

The scanner 380 reads an image on a surface of the sheet 340 (ACT 112).

As described above, the image reading unit 200 (the image reading apparatus) according to the embodiment includes the first sensor 320, the roller 310, the correction unit 330, the second sensor 350, the processor 180, and the scanner 380. Upstream to downstream positions with regard to the transportation direction of the sheet 340 are determined in the following order: the first position, the second position, the third position. The roller 310 detects the presence or absence of the fold of the sheet in the first position. If it is detected in the first position that the fold is present, the first sensor 320 transports a sheet in the reverse transportation direction. The correction unit 330 corrects the fold in the first position. The second sensor 350 detects the presence or absence of the fold 341 in the second position. If it is detected in the second position that the fold 341 is present, the processor 180 controls drive of the roller 310 in such a manner that the sheet 340 is transported up to the first position in the reverse transportation direction. The scanner 380 reads an image of the sheet 340 of which the fold 341 is corrected in the first position, in the third position.

According to at least one embodiment described above, the image reading unit 200 includes the processor 180 that controls the drive of the roller 310 in such a manner that, if it is detected in the second position that the fold 341 of the sheet 340 is present, the sheet 340 is transported up to the first position in the reverse transportation direction, and thus the probability that the fold 341 of the sheet 340 will be corrected can be improved.

The image reading unit 200 can prevent the sheet 340 from being blocked. The image reading unit 200 can prevent a mistake from occurring in reading an image.

While certain embodiments have been described these embodiments have been presented by way of example only, and are not intended to limit the scope of the inventions. Indeed, the novel embodiments described herein may be embodied in a variety of other forms. Furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An image reading apparatus comprising;
a first sensor configured to detect the presence or absence of a fold of a sheet in a first position, with upstream to downstream positions with regard to a transportation direction of the sheet being determined in the following order: the first position, a second position, a third position;
a roller configured to transport the sheet in the reverse transportation direction if in the first position, the fold is determined as being present;
a correction unit configured to correct the fold in the first position;
a second sensor configured to detect the presence or absence of the fold in the second position;
a control unit configured to control drive of the roller in such a manner that the sheet is transported up to the first position in a reverse transportation direction, if it is detected in the second position that the fold is present; and
a scanner configured to read an image on the sheet of which the fold is corrected in the first position, in the third position.

2. The apparatus according to claim 1,
wherein the correction unit is a member that comes into contact with the fold in the first position.

3. The apparatus according to claim 1,
wherein the roller presses down the fold in the first position and re-corrects the fold.

4. The apparatus according to claim 1,
wherein a plurality of the second sensors are provided, and
wherein the control unit determines whether or not the sheet is inclined with respect to the transportation direction, based on results of detection by the plurality of the second sensors, and, if the sheet is determined as being inclined, notifies that the sheet is positioned in a state of being inclined.

5. The apparatus according to claim 1, further comprising:
an auxiliary correction unit that presses down a trace of the fold.

6. The apparatus according to claim 1,
wherein a plurality of the correction units are provided, and
wherein, among the plurality of the correction units, a first correction unit is provided in such a manner as to come into contact with an upper surface of the sheet, and a second correction unit is provided in such a manner as to come into contact with a lower surface of the sheet.

7. The apparatus according to claim 1,
wherein the control unit changes an angle that the correction unit and the sheet makes with respect to each other in such a manner that the correction unit is stuck by the fold, if processing that corrects the fold is re-performed.

8. The apparatus according to claim 1,
wherein the roller transports the sheet from the second position in the reverse transportation direction at a transportation speed that is different from a transportation speed that is applied when the sheet is transported in the transportation direction, if it is detected in the first position that the fold is present.

9. An image reading apparatus comprising:
a sensor configured to detect the presence or absence of a fold of a sheet in a first position, with upstream to downstream positions with regard to a transportation direction of the sheet being determined in the following order: the first position, a second position, a third position;
a roller configured to transport the sheet from the second position in a reverse transportation direction at a transportation speed that is different from a transportation speed that is applied when the sheet is transported in the transportation direction, if it is detected in the first position that the fold is present;
a correction unit that corrects the fold in the first position; and
a scanner configured to read an image on the sheet of which the fold is corrected in the first position, in the third position.

10. An image reading method that is performed by an image reading apparatus with upstream to downstream positions with regard to a transportation direction of the sheet being determined in the following order: the first position, a second position, a third position, the method comprising:
detecting the presence or absence of a fold of the sheet in the first position;
transporting the sheet in a reverse transportation direction if it is detected in the first position that the fold is present;
correcting the fold in the first position;
detecting the presence or absence of the fold in the second position;
controlling drive of a roller in such a manner that the sheet is transported up to the first position in a reverse transportation direction, if it is detected in the second position that the fold is present; and
reading an image on the sheet of which the fold is corrected in the first position, in the third position.
